(19) United States
(12) Patent Application Publication
(10) Pub. No.: US 2024/0329637 A1
(43) Pub. Date: Oct. 3, 2024

(54) MANAGEMENT SYSTEM, MANAGEMENT METHOD, AND STORAGE MEDIUM STORING PROGRAM

(71) Applicant: HONDA MOTOR CO., LTD., Tokyo (JP)

(72) Inventors: Koichi TSUNO, Saitama (JP); Tetsuya MATSUHISA, Saitama (JP)

(73) Assignee: HONDA MOTOR CO., LTD., Tokyo (JP)

(21) Appl. No.: 18/129,519

(22) Filed: Mar. 31, 2023

(51) Int. Cl. G05D 1/02; H04W 4/40; H04W 64/00

(52) U.S. Cl. CPC G05D 1/0217; H04W 4/40; H04W 64/003

(57) ABSTRACT

A management system of an autonomously movable work machine includes: a processing circuitry, in which the processing circuitry receives a work request, formulates an operation plan of the work machine based on the work request, the operation plan including a movement path of the work machine in a working area of the work machine, assigns the work request to the work machine based on the operation plan, acquires wireless communication environment data on the movement path collected by the work machine, and creates a wireless communication environment map of the working area using the acquired wireless communication environment data. The processing circuitry formulates the operation plan based on a data acquisition state of each section in the working area on the wireless communication environment map.

### TECHNICAL FIELD

The present invention relates to a management system for an autonomously movable work machine, a management method, and a storage medium storing a program for causing a computer to execute the management method.

### BACKGROUND ART

Autonomously movable work machines are used for various purposes, and for example, are used for work in dangerous environments for humans to work directly. This type of work machine periodically transmits information such as a state of the work machine and surrounding situation to a management server via wireless communication. The information transmitted from the work machine to the management server is monitored by a user. For example, at a point where attention is required to be paid to movement of the work machine, the user remotely confirms safety based on a surrounding image transmitted from the work machine, and after safety is confirmed, the user gives movement permission to the work machine.

A remote control device described in JP2013-052462A generates a wireless quality map indicating a wireless communication environment of each point in a working area. When the remote control device detects deterioration of the wireless communication environment on a movement path of a work machine, the remote control device refers to a wireless quality map to specify a movement destination of a predetermined wireless communication environment or more, and controls the work machine so as to move the work machine to the specified movement destination.

An aspect of the present disclosure relates to provide a management system capable of grasping a wireless communication environment in a working area.

### SUMMARY OF INVENTION

According to an aspect of the present disclosure, there is provided a management system of an autonomously movable work machine includes: a processing circuitry, in which the processing circuitry receives a work request, formulates an operation plan of the work machine based on the work request, the operation plan including a movement path of the work machine in a working area of the work machine, assigns the work request to the work machine based on the operation plan, acquires wireless communication environment data on the movement path collected by the work machine, and creates a wireless communication environment map of the working area using the acquired wireless communication environment data. The processing circuitry formulates the operation plan based on a data acquisition state of each section in the working area on the wireless communication environment map.

### BRIEF DESCRIPTION OF DRAWINGS

FIG. 1 is a diagram showing an example of a management system for describing an embodiment of the present invention;

FIG. 2 is a diagram showing an example of work executed by a work machine of FIG. 1;

FIG. 3 is a diagram showing an example of a wireless communication environment map created in the management system of FIG. 1;

FIG. 4 is a diagram showing an example of a process performed by the management system of FIG. 1;

FIG. 5A is a diagram showing an example of formulation of an operation plan in the process of FIG. 4;

FIG. 5B is a diagram showing the example of the formulation of the operation plan in the process of FIG. 4;

FIG. 5C is a diagram showing the example of the formulation of an operation plan in the process of FIG. 4;

FIG. 5D is a diagram showing the example of the formulation of the operation plan in the process of FIG. 4:

FIG. 6A is a diagram showing another example of the formulation of the operation plan;

FIG. 6B is a diagram showing the other example of the formulation of the operation plan;

FIG. 6C is a diagram showing the other example of the formulation of the operation plan;

FIG. 7 is a diagram showing still another example of the formulation of the operation plan; and

FIG. 8 is a diagram showing the still another example of the formulation of the operation plan.

### DESCRIPTION OF EMBODIMENTS

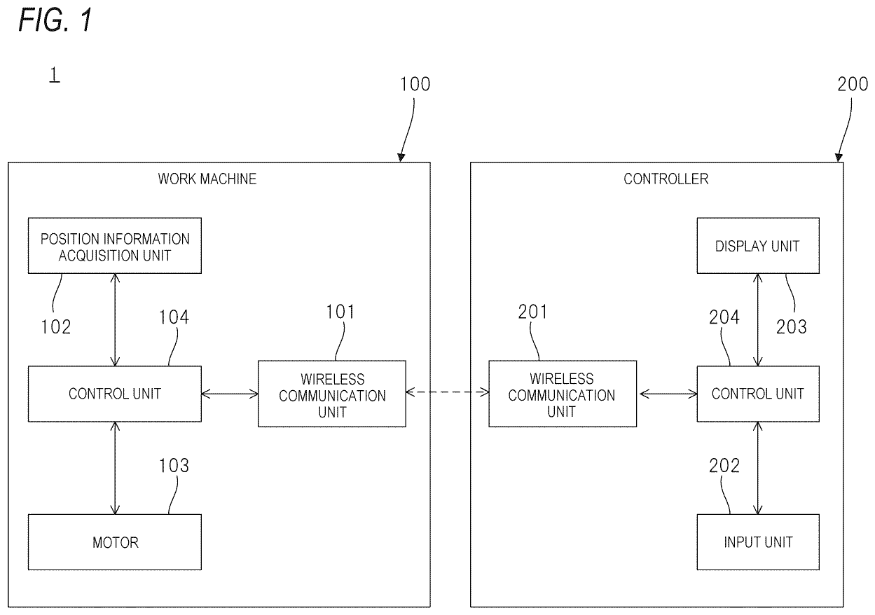

FIG. 1 shows an example of a management system.

A management system 1 shown in FIG. 1 includes an autonomously movable work machine 100 and a controller 200. The work machine 100 can communicate with the controller 200 via wireless communication. The work machine 100 receives various commands from the controller 200 and moves and works according to the received commands. The work machine 100 is, for example, a transport machine that transports packages, but may be a civil engineering machine such as a power shovel. The work machine 100 typically travels by wheels or crawlers, and uses a motor as a power source, but a movement form and the power source are not particularly limited as long as the work machine 100 can move autonomously.

The work machine 100 includes a wireless communication unit 101, a position information acquisition unit 102, a motor 103 as the power source, and a control unit 104. The control unit 104 includes a processor capable of executing a program and a storage device such as a read only memory (ROM) for storing the program, and controls the wireless communication unit 101, the position information acquisition unit 102, and the motor 103 by operating the processor according to the program.

The wireless communication unit 101 receives various wireless signals including the commands transmitted from the controller 200 to the work machine 100, and transmits various wireless signals including information such as wireless communication environment data collected by the work machine 100 to the controller 200. The wireless communication unit 101 performs wireless communication using a mobile communication system such as 4G or 5G. Further, the wireless communication unit 101 can measure radio wave intensity of the wireless signals at a current position of the work machine 100. The wireless communication unit 101 has a hardware configuration for performing the wireless communication, such as an antenna, a transmission and reception circuit, a modulation and demodulation circuit, and an encoding and decoding circuit.

The position information acquisition unit 102 measures the current position of the work machine 100. The position information acquisition unit 102 has a hardware configuration such as a global positioning system (GPS) circuit. The position information acquisition unit 102 may include various sensor circuits such as an acceleration sensor and a gyro sensor for implementing an autonomous navigation function in addition to the GPS circuit. Accordingly, even when the GPS signal cannot be received, the current position of the work machine 100 can be estimated using the autonomous navigation function.

The control unit 104 drives the motor 103 as the power source based on the command received from the controller 200, and controls various operations that can be executed by the work machine 100. For example, the control unit 104 supplies power from the motor 102 to the wheels and the crawlers to move the work machine 100 in a direction and a speed according to the command.

The controller 200 includes a wireless communication unit 201, an input unit 202, a display unit 203, and a control unit 204. The control unit 204 includes a processor capable of executing a program and a storage device such as a read only memory (ROM) for storing the program, and controls the wireless communication unit 201, the input unit 202, and the display unit 204 by operating the processor according to the program.

The wireless communication unit 201 transmits the various wireless signals including a command for the work machine 100 to the work machine 100, and receives the various wireless signals including the information such as the wireless communication environment data collected by the work machine 100. The wireless communication unit 201 performs wireless communication using a mobile communication system such as 4G or 5G. The wireless communication unit 201 has a hardware configuration for performing the wireless communication, such as an antenna, a transmission and reception circuit, a modulation and demodulation circuit, and an encoding and decoding circuit.

The input unit 202 has an appropriate hardware configuration such as a keyboard, a mouse, and a button, and receives an operation of a user such as input of a work request and confirmation of a command for the work machine 100.

The display unit 203 has a hardware configuration such as a display, and displays, for example, various types of information such as a list or progress of the work request, and a situation of the work machine 100. The display unit 203 may display an image around the work machine 100, which is acquired by a camera provided in the work machine 100 and transmitted from the work machine 100. The user may input a command to be given to the work machine 100 to the input unit 202 while confirming the image displayed on the display unit 203.

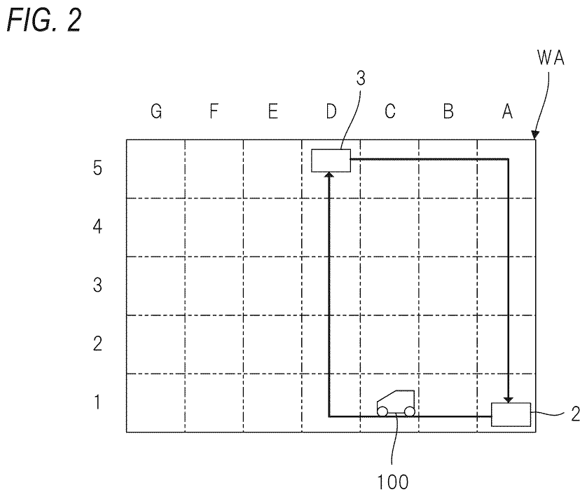

FIG. 2 shows an example of work executed by the work machine 100.

The work machine 100 transports packages in a working area WA. Specifically, the work machine 100 loads the packages on a work machine base 2, moves from the work machine base 2 to a destination 3, unloads the packages at the destination 3, and then returns to the work machine base 2. The work machine 100 receives a command that instructs the above-described work from the controller 200 via the wireless communication. The work machine 100 that has received the command reciprocates between the work machine base 2 and the destination 3 along a movement path instructed by the command.

The work machine 100 periodically transmits information to the controller 200 during work execution. The information transmitted from the work machine 100 to the controller 200 includes state information related to a state of the work machine 100, such as the current position, a moving speed, and a battery residual capacity of the work machine 100, and task information related to a task currently executed by the work machine 100, such as loading or unloading of a package. The information transmitted from the work machine 100 to the controller 200 may include image information around the work machine 100. The information transmitted from the work machine 100 to the controller 200 further includes environment information related to the wireless communication environment such as the radio wave intensity of the wireless signal at the current position. When transmitting these types of information to the controller 200, the work machine 100 transmits time information indicating a transmission time together.

Note that, due to a temporary increase in communication traffic of a wireless base station covering the working area WA, the wireless communication environment at the current position of the work machine 100 may temporarily deteriorate, and a communication band (communication speed) may be limited. In such a case, the work machine 100 may periodically transmit, to the controller 200, only important information for the operation of the work machine 100. The remaining information is temporarily held in the storage device provided in the control unit 104, and is transmitted to the controller 200 after recovery of the wireless communication environment around the work machine 100. Accordingly, even when the communication band is limited, the operation of the work machine 100 can be continued as much as possible. The important information for the operation of the work machine 100 is, for example, the task information and the image information. When the communication band is limited, the work machine 100 may extend a transmission interval when transmitting the information to the controller 200.

The controller 200 acquires the wireless communication environment data that is collected by the work machine 100 and is on the movement path of the work machine 100. Then, the controller 200 creates a wireless communication environment map of the working area WA using the acquired wireless communication environment data.

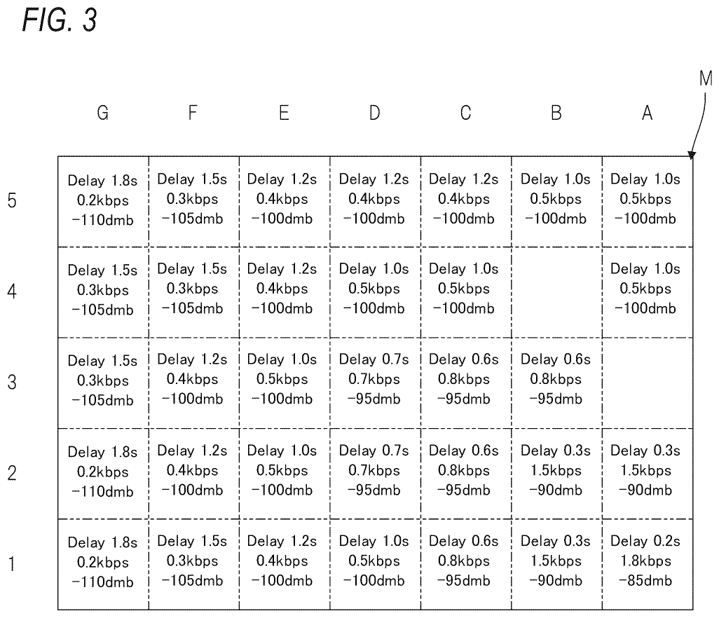

FIG. 3 shows an example of the wireless communication environment map.

The wireless communication environment data includes, for example, a communication delay, the communication band, and the radio wave intensity. The communication delay is calculated by the control unit 204 of the controller 200 based on a difference between a time indicated by the time information embedded in the information transmitted from the work machine 100 to the controller 200 and a time when the controller 200 receives the information. The communication band is calculated by the control unit 204 based on a size of the information transmitted from the work machine 100 to the controller 200 and time (communication delay) required to transmit and receive the information. The radio wave intensity is measured by the wireless communication unit 101 of the work machine 100, and is included in the information transmitted from the work machine 100 to the controller 200.

The information transmitted from the work machine 100 to the controller 200 includes information indicating a position of the work machine 100 when the work machine 100 transmits the information. The control unit 204 of the controller 200 maps the wireless communication environment data on a map of the working area WA based on positions associated with the wireless communication environment data to create and update a wireless communication environment map M of the working area WA.

A mapping method is not particularly limited, but in the example shown in FIG. 3, the control unit 204 divides the working area WA into a plurality of sections and applies wireless communication environment data to the sections including the positions associated with the wireless communication environment data. Then, when newly applying wireless communication environment data to one section, the control unit 204 obtains a time-series moving average of a plurality of pieces of wireless communication environment data, and updates values of the section (the value of each index of the communication delay, the communication band, and the radio wave intensity) by the obtained moving average.

In the example shown in FIG. 3, the wireless communication environment data is not mapped in a section A-3 and a section B-4, but this indicates that the wireless communication environment data is not acquired for the section A-3 and the section B-4, or that the wireless communication environment data is not updated exceeding a predetermined time. The control unit 204 formulates an operation plan of the work machine 100 based on a data acquisition state of each section in the working area WA on the wireless communication environment map M.

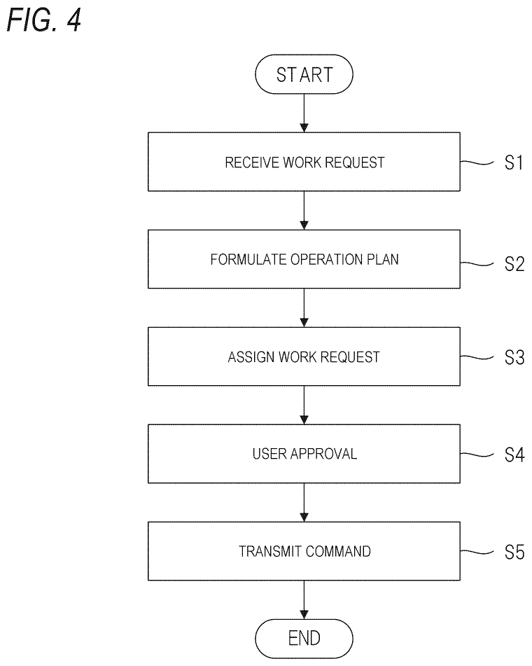

FIG. 4 shows an example of a process including the formulation of the operation plan performed by the control unit 204.

The control unit 204 receives a work request (step S1). The control unit 204 formulates an operation plan of the work machine 100 based on the received work request (step S2). Next, the control unit 204 assigns a work request to the work machine 100 based on the formulated operation plan (step S3). Then, after user approval for the assignment of the work request to the work machine 100 (step S4), the control unit 204 transmits a command that instructs the work to the work machine 100 according to the assignment of the approved work request (step S5).

The operation plan includes the movement path of the work machine 100 in the working area WA, and the control unit 204 formulates the operation plan such that a section in which the wireless communication environment data is missing and a section in which the wireless communication environment data is not updated exceeding a predetermined time among the sections in the working area WA on the wireless communication environment map M are preferentially included in the movement path. Further, the control unit 204 may further formulate the operation plan based on a wireless communication environment of each section in the working area WA and/or a road surface condition of each section in the working area WA.

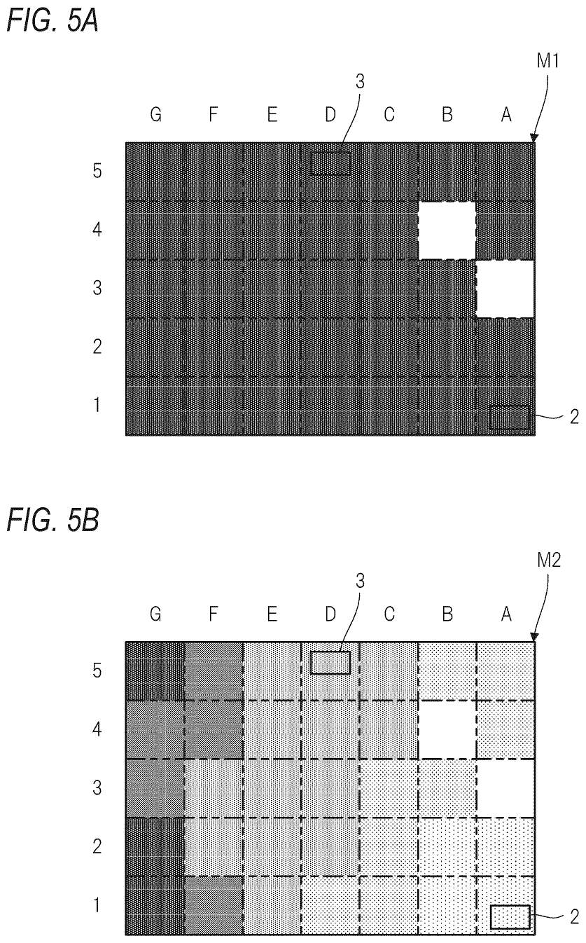

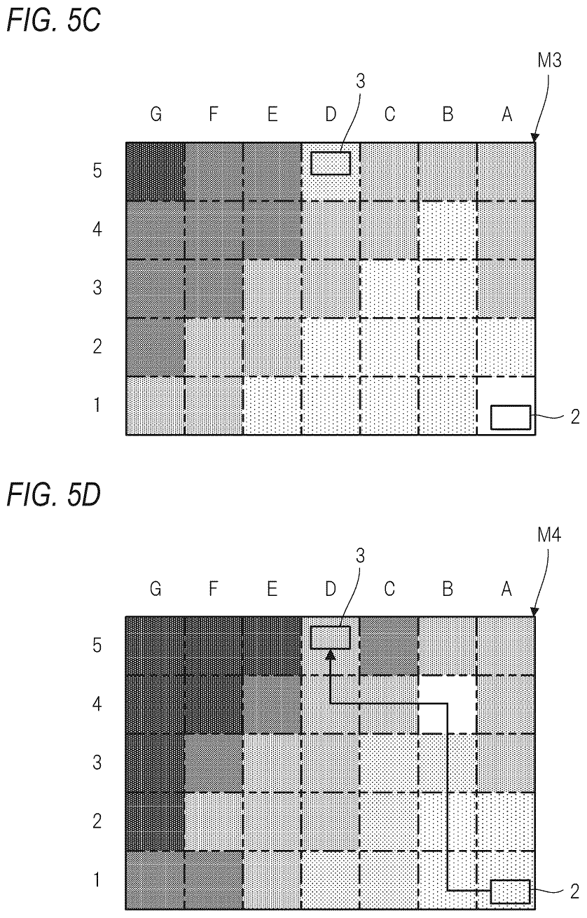

FIGS. 5A to 5D show an example of formulation of the operation plan.

The control unit 204 formulates the operation plan based on whether the section is a section (hereinafter, referred to as a priority section) to be preferentially included in the movement path, the wireless communication environment of each section, and the road surface condition of each section, and the control unit 204 evaluates whether the section is the priority section, the wireless communication environment of each section, and the road surface condition of each section, weights these evaluation items, and calculates a weighted average of evaluation values for each section. In the following description, it is assumed that the smaller the evaluation value common to all the evaluation items, the higher a possibility that the section is included in the movement path.

An evaluation value map M1 shown in FIG. 5A relates to the priority section. The evaluation value map M1 is created based on the wireless communication environment map M. In FIG. 5A, a magnitude of the evaluation value is represented in two graduations of black and white, and sections having a small evaluation value, that is, the priority sections, are white.

An evaluation value map M2 shown in FIG. 5B is related to the wireless communication environment of each section, and the wireless communication environment affects stable movement of the work machine 100. The evaluation value map M2 is created based on the wireless communication environment map M. In FIG. 5B, a magnitude of the evaluation value is represented by a gray scale, and sections having a smaller evaluation value, that is, having a better wireless communication environment, have a lighter color.

An evaluation value map M3 shown in FIG. 5C is related to the road surface condition of each section, and the road surface condition affects an amount of electric power required for movement. The evaluation value map M3 is created in advance based on an actual survey by the user or a change in the battery residual capacity when the work machine 100 moves. In FIG. 5C, a magnitude of the evaluation value is represented by a gray scale, and a section having a smaller evaluation value, that is, in which the road surface condition is flat and suitable for movement of the work machine 100 has a lighter color.

An evaluation value map M4 shown in FIG. 5D is obtained by weighting the evaluation value map M1 related to the priority section, the evaluation value map M2 related to the wireless communication environment of each section, and the evaluation value map M3 related to the road surface condition of each section and superimposing these evaluation value maps. In the evaluation value map M4, the control unit 204 selects a path between the work machine base 2 and the destination 3 in which the sum of the evaluation values is minimum as the movement path of the work machine 100.

The weighting on the evaluation value map M1 related to the priority section, the evaluation value map M2 related to the wireless communication environment of each section, and the evaluation value map M3 related to the road surface condition of each section may be appropriately set according to the importance of the evaluation items.

According to the above-described formulation of the operation plan, the section in which the wireless communication environment data is missing and the section in which the wireless communication environment data is not updated exceeding a predetermined time are preferentially included in the movement path. Accordingly, it is possible to comprehensively and efficiently grasp the wireless communication environment of the working area WA.

Further, by formulating the operation plan based on the wireless communication environment of each section, it is possible to collect the wireless communication environment data of the priority section without taking an excessive risk. Further, by formulating the operation plan based on the road surface condition of each section, it is possible to collect the wireless communication environment data of the priority section without excessive cost.

The evaluation items in the formulation of the operation plan are not limited to whether the section is the priority section, the wireless communication environment of each section, and the road surface condition of each section. For example, when the management system 1 includes a plurality of work machines 100, the control unit 204 may formulate an operation plan based on movement path(s) of the work machine(s) 100 that has not been completed the work request assigned thereto. Accordingly, the plurality of work machines 100 can be prevented from approaching each other in the working area WA, and it is possible to stably move the plurality of work machines 100 by suppressing the occurrence of communication band interference between the plurality of work machines 100.

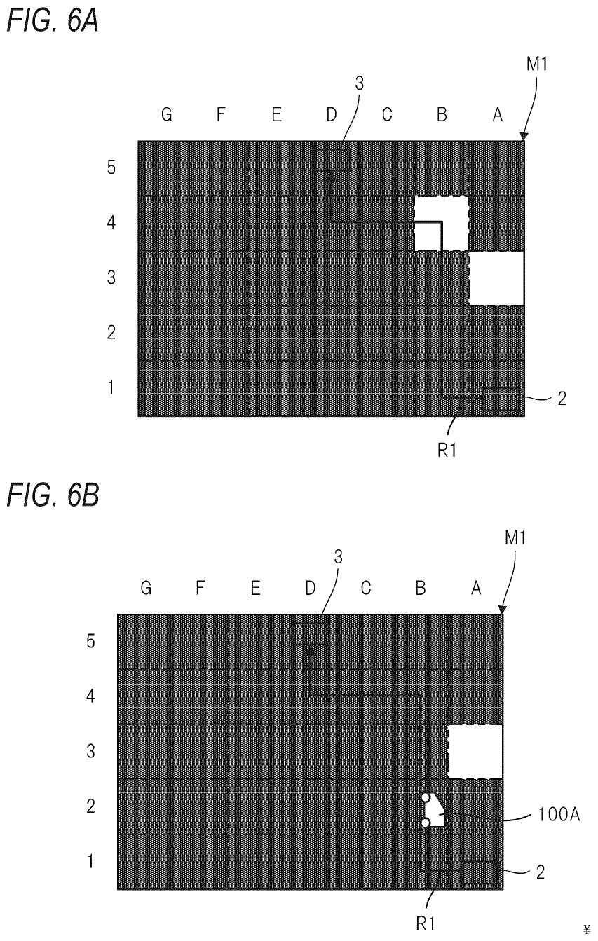

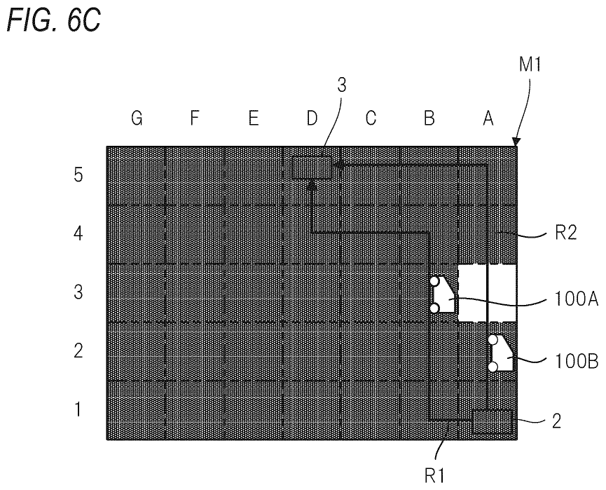

FIGS. 6A to 6C show another example of the formulation of the operation plan.

In the example shown in FIGS. 6A to 6C, the management system 1 includes a work machine 100A and a work machine 100B, and the control unit 204 of the controller 200 formulates operation plans of the work machine 100A and the work machine 100B.

FIG. 6A shows the evaluation value map M1 related to the priority section, and the evaluation value map M1 is created based on the wireless communication environment map M. In FIG. 6A, the magnitude of the evaluation value is represented in two graduations of black and white, and sections having a small evaluation value, that is, the priority sections, are white. In the example of FIG. 6A, the section A-3 and the section B-4 are priority sections.

The control unit 204 receives a work request A and formulates an operation plan based on the work request A. Here, it is assumed that a movement path R1 including the section B-4, which is one of the section A-3 and the section B-4, which are the priority sections, is selected in accordance with a method for formulating the operation plan described with reference to FIGS. 5A to 5D. The control unit 204 assigns the work request A to the work machine 100A based on the formulated operation plan, and transmits a command that instructs the work to the work machine 100A.

Then, the control unit 204 assumes that the wireless communication environment data on the movement path R1 along which the work machine 100A moves has been acquired at the time when the work request A is assigned to the work machine 100A, and changes the evaluation values of the sections on the movement path R1 on the evaluation value map M1.

As shown in FIG. 6B, the work machine 100A that has received the command corresponding to the work request A moves along the movement path R1 in accordance with the command. The work machine 100A collects the wireless communication environment data on the movement path R1 while moving along the movement path R1, and transmits the collected wireless communication environment data to the controller 200.

Subsequently, the control unit 204 receives a work request B and formulates the operation plans of the work machine 100A and the work machine 100B based on the work request B. The control unit 204 assigns the work request B to the work machine 100B based on the formulated operation plan, and transmits a command that instructs the work to the work machine 100B.

Here, when the wireless communication environment data of the section B-4 has already been collected by the work machine 100A to which the work request A is assigned and the controller 200 has already acquired the wireless communication environment data of the section B-4, the section B-4 is excluded from the priority sections. Accordingly, a movement path R2 including the section A-3, which is the priority section, is selected.

On the other hand, as shown in FIG. 6C, when the work machine 100A to which the work request A is assigned does not reach the section B-4 and the controller 200 does not acquire the wireless communication environment data of the section B-4, as described above, the control unit 204 assumes that the wireless communication environment data on the movement path R1 along which the work machine 100A moves has been acquired at the time when the work request A is assigned to the work machine 100A, and the evaluation values of the sections on the movement path R1 on the evaluation value map M1 are changed. That is, the section B-4 is excluded from the priority sections on the evaluation value map M1. Accordingly, the movement path R2 including the section A-3, which is the priority section, is selected.

As described above, when the work request A is assigned to one work machine 100A, which is one of the plurality of work machines 100A and 100B, by assuming that the wireless communication environment data on the movement path R1 along which the work machine 100A moves is acquired, a different movement path R2 for the work request B following the work request 100A can be selected. Accordingly, the wireless communication environment data can be efficiently collected.

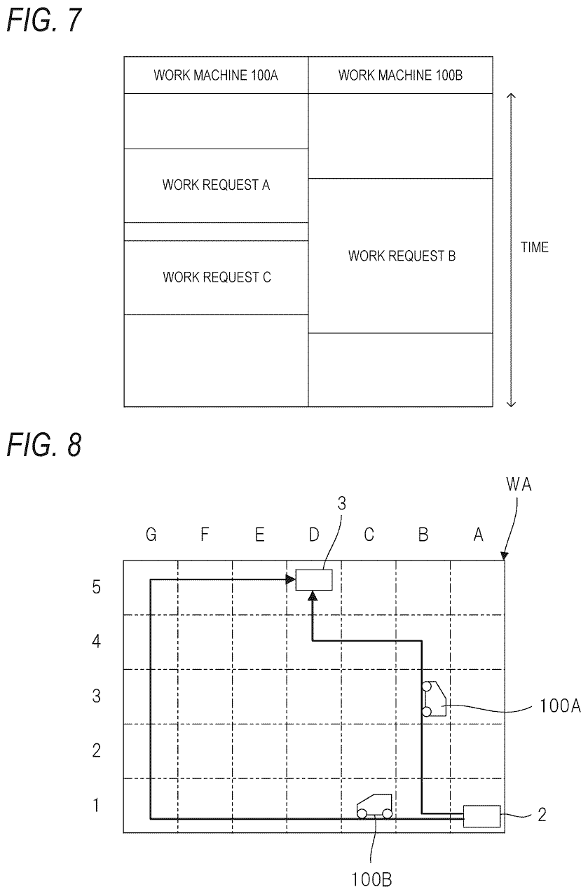

FIGS. 7 and 8 show still another example of the formulation of the operation plan.

In the above description, the control unit 204 of the controller 200 receives work requests at any time and sequentially performs the formulation of the operation plan and the assignment of the work requests based on the work requests in the order of reception, but the control unit 204 may formulate the operation plans based on the plurality of work requests.

In the example shown in FIG. 7, the control unit 204 formulates the operation plan based on work requests A, B, and C. First, the control unit 204 assigns the work request B to the work machine 100B, and assigns the work request A and the work request C to the work machine 100A before the work machine 100B completes the work request B. Here, the control unit 204 sets a length of the movement path for each of the work requests A and C assigned to the work machine 100A to be shorter than a length of the movement path for the work request B assigned to the work machine 100B.

According to the above-described method for formulating the operation plan, as shown in FIG. 8, the work machine 100A collects wireless communication environment data of a section located at a relatively short distance from the work machine base 2, and the work machine 100B collects wireless communication environment data of a section located at a relatively long distance from the work machine base 2. Time taken for the work machine 100A to collect the wireless communication environment data is substantially the same as time taken for the work machine 100B to collect the wireless communication environment data. Accordingly, it is possible to comprehensively and efficiently grasp the wireless communication environment of the working area WA.

What is claimed is:

1. A management system of an autonomously movable work machine, the management system comprising processing circuitry,
wherein the processing circuitry is configured to:
receive a work request;
formulate an operation plan of the work machine based on the work request, the operation plan including a movement path of the work machine in a working area of the work machine;
assign the work request to the work machine based on the operation plan;
acquire wireless communication environment data on the movement path collected by the work machine; and
create a wireless communication environment map of the working area using the acquired wireless communication environment data, and
wherein the processing circuitry formulates the operation plan based on a data acquisition state of each section in the working area on the wireless communication environment map.

2. The management system according to claim 1,
wherein the processing circuitry formulates the operation plan such that a section in which the wireless communication environment data is missing and a section in which the wireless communication environment data is not updated exceeding a predetermined time among the sections in the working area on the wireless communication environment map are preferentially included in the movement path.

3. The management system according to claim 2,
wherein the work machine includes a plurality of work machines, and
wherein when the work request is assigned to one work machine among the plurality of work machines, the processing circuitry assumes that the wireless communication environment data on the movement path along which the work machine moves is acquired.

4. The management system according to claim 1,
wherein the processing circuitry formulates the operation plan based further on a wireless communication environment of each section in the working area.

5. The management system according to claim 1,
wherein the processing circuitry further formulates the operation plan based on a road surface condition of each section in the working area.

6. The management system according to claim 1,
wherein the work machine includes a plurality of work machines, and
wherein the processing circuitry formulates the operation plan based further on the movement path of the work machine that has not completed the work request assigned thereto.

7. The management system according to claim 1,
wherein the work machine includes a first work machine and a second work machine,
wherein the processing circuitry assigns a plurality of work requests to the first work machine before the second work machine completes the work request assigned to the second work machine, and
wherein a length of the movement path for each of the plurality of work requests assigned to the first work machine is shorter than a length of the movement path for the work request assigned to the second work machine.

8. A management method for an autonomously movable work machine, the management method comprising a computer-implemented steps of:
receiving a work request;
formulating an operation plan of the work machine based on the work request, the operation plan including a movement path of the work machine in a working area of the work machine;
assigning the work request to the work machine based on the operation plan;
acquiring wireless communication environment data on the movement path collected by the work machine; and
creating a wireless communication environment map of the working area using the acquired wireless communication environment data,
wherein the operation plan is formulated based on a data acquisition state of each section in the working area on the wireless communication environment map.

9. A non-transitory computer-readable storage medium storing a program for causing a computer to execute the management method according to claim 8.
